(19) United States
(12) Patent Application Publication
(10) Pub. No.: US 2002/0171069 A1
(43) Pub. Date: Nov. 21, 2002

(54) Machine for pulling sheets of material

(76) Inventor: Jan Kochanski, West Orange, NJ (US)

Correspondence Address: Jan Kochanski, 75 Lessing Road, West Orange, NJ, 07052, US

(21) Appl. No.: 09/861,053

(22) Filed: May 18, 2001

(51) Int. Cl. B66F 3/00

(52) U.S. Cl. 254/17

(57) ABSTRACT

A machine for pulling sheets of material. with of a leverage handle connected to a stand and track for stability, Jaws for gripping material, Pulling and angle regulator arm to change angle of pull, Pulling arm to allow for right side or left side operation, Sliding arm connected to pushing arm which in turn is connected to leverage handle to provide back and forward movement of the jaws, A preferred embodiment includes the pulling and angle regulator arm can be adjusted to three different positions providing different angles of pull.

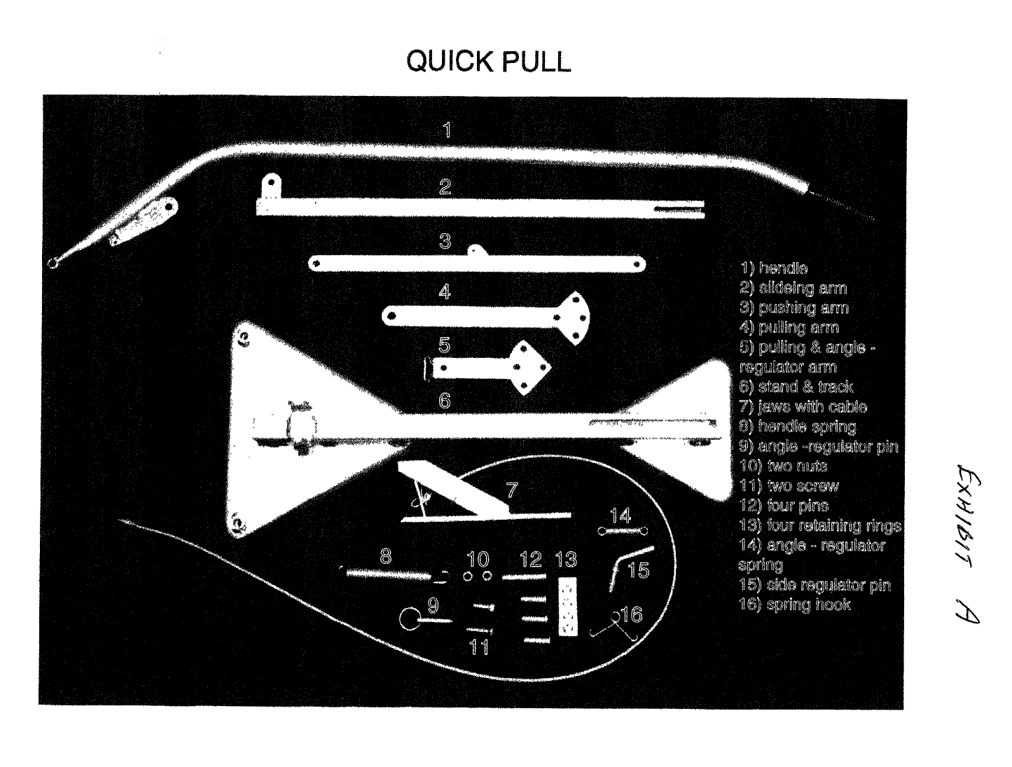

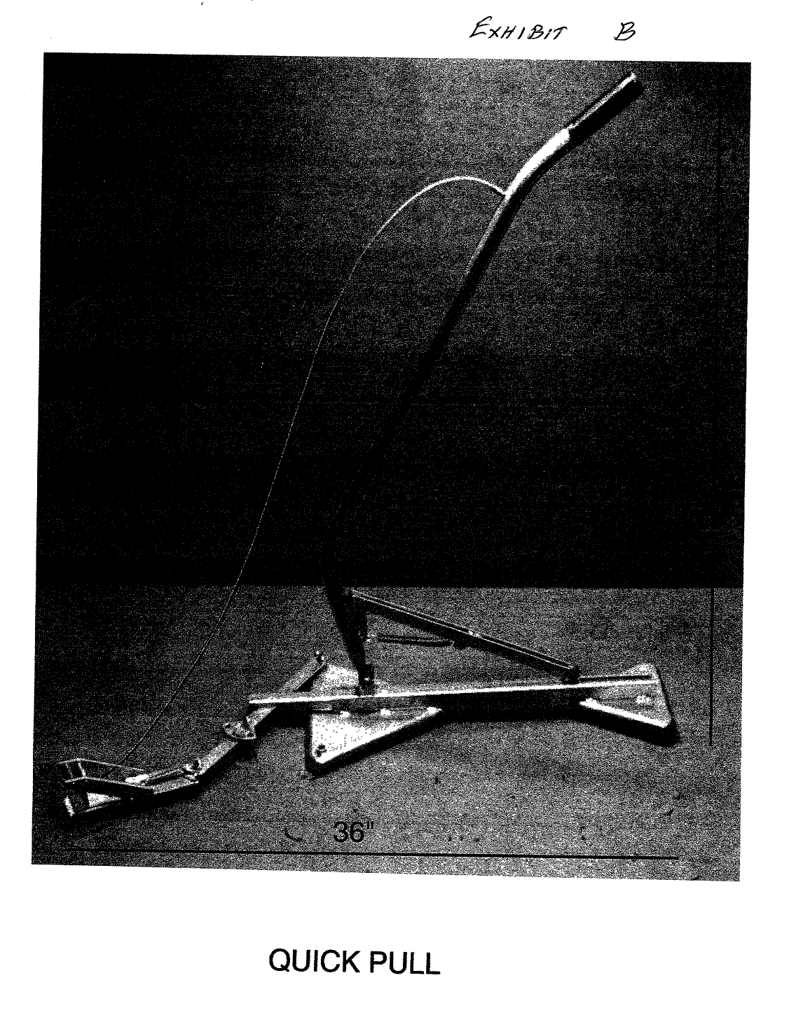

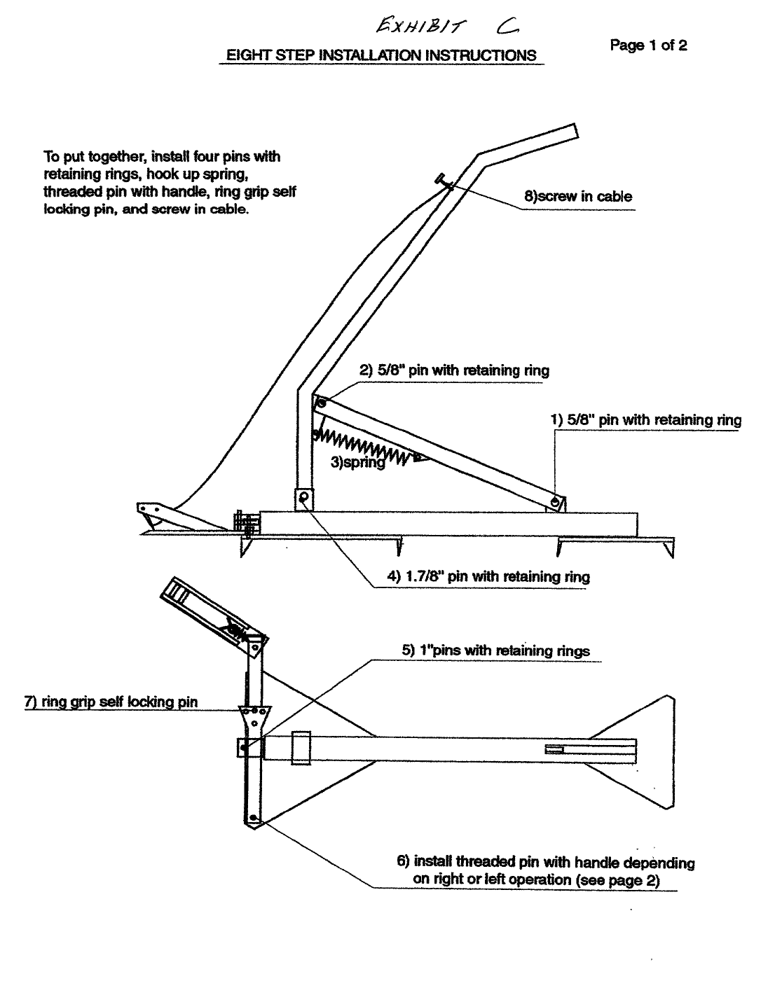

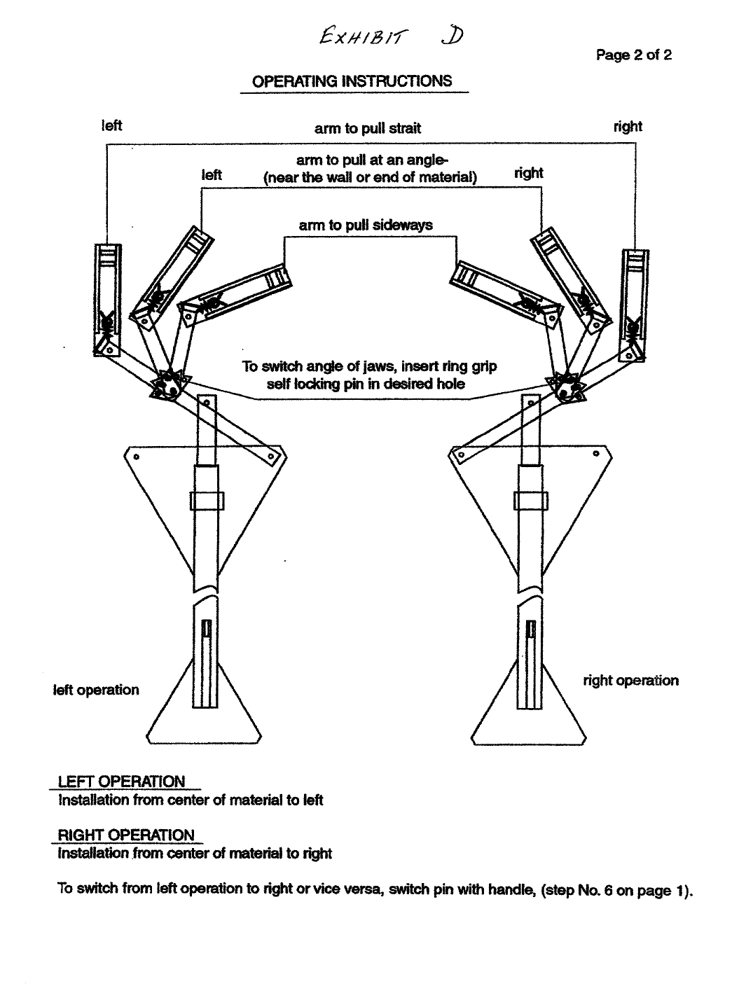

The gripping action is a simple method requiring no bending, adjusting and efortless.

### BACKGROUND OF THE INVENTION

This invention relates generally to the roofing industry, and more particularly to a machine for pulling sheets of material.

Inventor had on the job experience with current machine claiming to pull material. This machine was very difficult to work with, requiring bending and manually hand operating vise that grips material and again bending over to open the vise. The vise requires periodic adjustment, the material is pulled by a cable attached to the vise, which occasionally breaks. The design of the machine requires both hands to operate and the weight of the machine is concentrated on one end making it uncomfortable to move.

### SUMMARY OF THE INVENTION

The primary object of the invention is To provide for a simpler, faster and more efficient means of pulling sheets of material.

Another object of this invention is to provide a machine that can be handled easily because of equal distribution of weight from the handle.

Another object of this invention is to provide a machine that requires less adjustments.

Another object of this invention is to provide a machine with which you can easily double your output of production.

Other objects and advantages of the present invention will become apparent from the following descriptions, taken in connection with the accompanying drawings, wherein, by way of illustration and example, an embodiment of the present invention is disclosed.

A machine for pulling sheets of material. comprising: of a leverage handle connected to a stand and track for stability, Jaws for gripping material, Pulling and angle regulator arm to change angle of pull, Pulling arm to allow for right side or left side operation, Sliding arm connected to pushing arm which in turn is connected to leverage handle to provide back and forward movement of the jaws,

In accordance with a preferred embodiment of the invention this invention includes a machine which will simplify, and be more productive in the pulling of sheets of material.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

Exhibit “A” is an exploded view of the invention.

Exhibit “B” is an assembled view of the invention.

Exhibit “C” is an eight step installation instructions.

Exhibit “D” is instructions for operating the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for pulling sheets of material. comprising: of a leverage handle connected to a stand and track for stability;
Jaws for gripping material;
Pulling and angle regulator arm to change angle of pull;
Pulling arm to allow for right side or left side operation;
Sliding arm connected to pushing arm which in turn is connected to leverage handle to provide back and forward movement of the jaws;

2 The invention as claimed in claim 1 wherein the pulling and angle regulator arm can be adjusted to three different positions providing different angles of pull.

3 The invention as claimed in claim 1 wherein the pulling arm can be switched to operate from center to right or center to left.

4 The invention as claimed in claim 1 wherein the jaws are designed to grab material without operator physically bending.
A sliding arm inside the stand and track is connected to the leverage handle by a pushing arm which moves the sliding arm forward and backward.
